(19) United States
(12) Patent Application Publication
(10) Pub. No.: US 2016/0031355 A1
(43) Pub. Date: Feb. 4, 2016

(54) Cart Buddy

(71) Applicant: Paul Michael Medina, SR., Haiku, HI (US)

(72) Inventor: Paul Michael Medina, SR., Haiku, HI (US)

(21) Appl. No.: 14/756,076

(22) Filed: Jul. 28, 2015

Related U.S. Application Data
(60) Provisional application No. 62/030,862, filed on Jul. 30, 2014.

(51) Int. Cl. B60P 1/64

(52) U.S. Cl. CPC B60P 1/64

(57) ABSTRACT

The dump cart liner of the present invention includes a shaped liner and a handle-strap. The liner is designed to fit into lawn, barn and utility dump carts and designed to remove dump material from the carts when the carts are in the dump position. Presently the only means to remove dump material from the carts in the dump position is by scraping the material out manually with shovel, rake or garden hoe.

### BACKGROUND OF THE INVENTION

1. Field of the Invention

The invention relates to lawn, barn and utility poly dump carts. More particularly, the invention relates to a liner for lawn, barn and utility poly dump carts.

2. State of the Art

Lawn, barn, and farm maintenance is a global on-going necessity. The state of the art lawn, barn and utility poly dump carts are extensively used in this activity.

Prior art FIG. 1 shows a typical poly dump cart with a dumping mechanism.

Prior art FIG. 2 shows a rectangular dump cart with a dumping mechanism.

Although these lawn, barn and utility poly dump carts are designed with a dump feature, the effectiveness of the dump feature leaves a lot to be desired due to the lack of complete removal of the contents of the lawn, barn and utility poly dump carts without the use of tools and manual labor. There is currently nothing available remedy this problem.

### SUMMARY OF THE INVENTION

It is therefore an object of the invention to provide a method of removing all contents of the lawn, barn and utility poly dump carts.

It is also an object of the invention to eliminate the need for shovel, rake or hoe to remove the complete contents of the lawn, barn and utility poly dump carts.

It is also an object of the invention to save time and physical exertion to completely remove the contents of the lawn, barn and utility poly dump carts.

### DESCRIPTION OF THE DRAWINGS

FIG. 1 is a perspective view of a prior art dump cart used for moving material from one place and dumping it in another location.

FIG. 2 is a perspective view of a prior art rectangular-style dump cart with removable tail gate.

FIG. 3 is a perspective view of the liner according to the invention for a dump-type cart.

FIG. 4 is a perspective view of the liner according to the invention from a different angle.

### DETAILED DESCRIPTION OF THE INVENTION

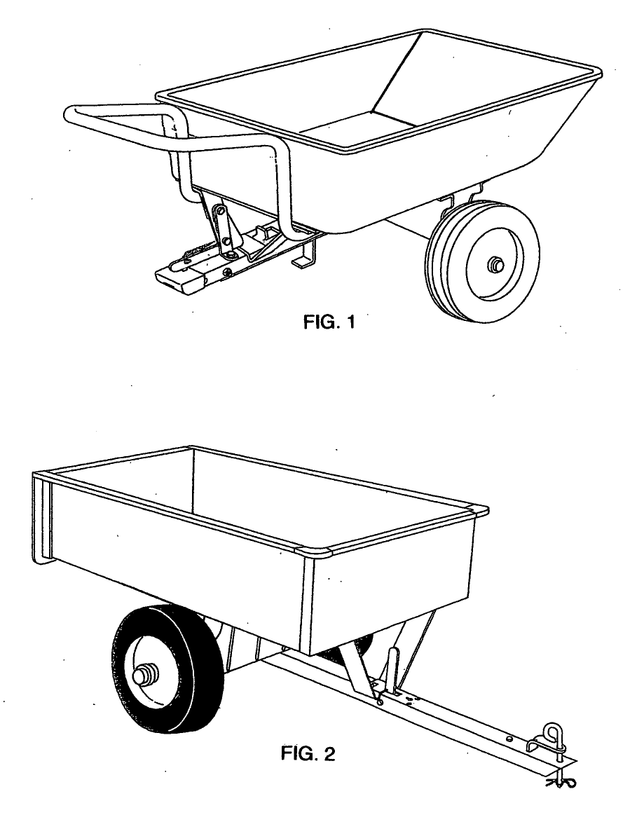

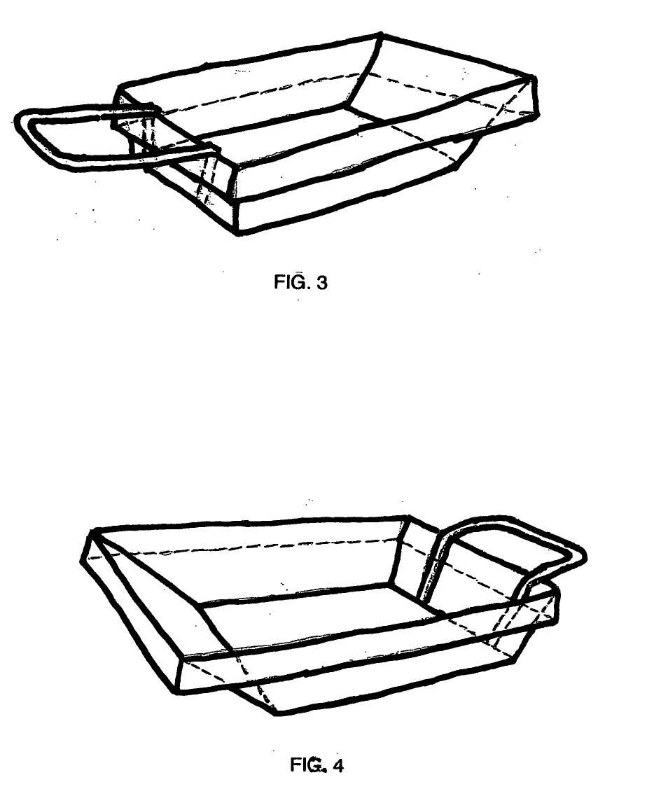

Referring to FIG. 3, a dump cart liner according to the invention is a shaped fabric with a handle-strap attached to the front-end. The liner is is shaped by sewing seams to form the corners that would conform to the shape of the dump style carts FIG. 1 and FIG. 2.

Another embodiment of a dump cart liner according to the invention is a handle-strap shown in FIG. 3 (a). The handle strap is sewn to the invention.

1. The invention comprising: a liner for lawn, barn and utility poly dump carts.

2. The liner of claim 1 comprising: material designed to conform to the interior of lawn, barn and utility poly dump carts.

3. The liner of claim 1 comprising: a strap attached (sewn) to said liner.

4. The liner of claim 1 comprising: seamed corners to conform to the shape of lawn, barn and utility poly dump carts.
